(19) United States
(12) Patent Application Publication
(10) Pub. No.: US 2024/0385496 A1
(43) Pub. Date: Nov. 21, 2024

(54) CAMERA MODULE AND DIGITAL DEVICE THEREOF

(71) Applicant: GALAXYCORE SHANGHAI LIMITED CORPORATION, Shanghai (CN)

(72) Inventors: Jun LUO, Shanghai (CN); Yong XU, Shanghai (CN)

(73) Assignee: GALAXYCORE SHANGHAI LIMITED CORPORATION, Shanghai (CN)

(21) Appl. No.: 18/693,106

(22) PCT Filed: Sep. 14, 2022
(86) PCT No.: PCT/CN2022/118634

§ 371 Date: Mar. 18, 2024

(30) Foreign Application Priority Data
Sep. 18, 2021 (CN) 202111103460.3

(51) Int. Cl. G03B 13/36; G02B 7/09; H04N 23/55

(52) U.S. Cl. CPC G03B 13/36; G02B 7/09; H04N 23/55; G03B 2205/0069

(57) ABSTRACT

The present disclosure provides a camera module, including: a movable assembly configured to drive a lens assembly to move along a direction of an optical axis; and an elastic device uniformly arranged configured to come into contact with the movable assembly to generate an elastic deformation to apply a squeezing force to the movable assembly. A resultant force direction of the squeezing force points towards the optical axis and is perpendicular to the optical axis. The elastic device includes a first elastic device and a second elastic device, and a resultant force direction of a squeezing force applied to the movable assembly by the first elastic device is opposite to a resultant force direction of a squeezing force applied to the movable assembly by the second elastic device. The present disclosure can ensure a stability of the movement of the camera module in a large stroke.

### CROSS-REFERENCE TO RELATED APPLICATIONS

This application is the National Phase of International Application No. PCT/CN2022/118634, filed on Sep. 14, 2022, which claims the priority to Chinese Patent Application No. 202111103460.3, filed on Sep. 8, 2021, with the China National Intellectual Property Administration, the entire contents of which are incorporated into this application by reference.

### TECHNICAL FIELD

The present disclosure relates to the technical field of camera modules, and more particularly to a camera module and a digital device including the camera module.

### BACKGROUND

At present, most mobile devices, such as mobile phones and tablet computers, are equipped with camera modules, which can realize a conversion between optical signals and electrical signals and record and save image information to realize functions of taking pictures and photographing. Compared with traditional camera systems, a cell phone camera module (CCM) is widely used in various new-generation portable camera devices due to its advantages of miniaturization, low power consumption, low cost and high image quality.

At present, a camera module includes a lens assembly, a voice coil motor (VCM), an infrared cut filter, an image sensor, a flexible printed circuit board (FPC) or a printed circuit board (PCB), and a connector connected with a mobile phone motherboard. The voice coil motor can realize an autofocus function of the lens assembly, and the voice coil motor usually includes magnets, coils and other structures. During an operation of the camera module, the coils are first powered on to cut magnetic induction lines in a magnetic field to generate an electromagnetic force, and the coils or magnets move under the action of the electromagnetic force, to drive the lens assembly connected with the voice coil motor to move to adjust an image distance and an object distance of the camera module and present a clear image. Usually, a Hall-effect sensor can also be installed in the voice coil motor, and the Hall-effect sensor can measure a change of the magnetic field in the voice coil motor, and realize a closed-loop control of the voice coil motor by determining a position of the coils or magnets according to the change of the magnetic field. Usually, the autofocus function in the cell phone camera module is completely accomplished by an entire driver.

With a rapid development of smartphone industry, people's requirements for an imaging effect of mobile phone cameras are gradually increasing. A zoom range of a focal length is an important factor affecting the imaging effect of the mobile phone cameras, which requires the voice coil motor to be able to perform a large stroke driving, while the large stroke driving requires maintaining a camera stability in a stroke range, which puts high demands on a stability of the voice coil motor.

### SUMMARY

An objective of the present disclosure is to provide a camera module with a large stroke and capable of maintaining stable movement of a lens assembly.

In order to solve the above problems, the present disclosure provides a camera module. The camera module includes a movable assembly and an elastic device. The movable assembly is configured to drive a lens assembly to move along a direction of an optical axis, and the elastic device is uniformly arranged around the movable assembly and configured to come into contact with the movable assembly to generate an elastic deformation to apply a squeezing force to the movable assembly. A resultant force direction of the squeezing force points towards the optical axis and is perpendicular to the optical axis. The elastic device includes a first elastic device and a second elastic device, and a resultant force direction of a squeezing force applied to the movable assembly by the first elastic device is opposite to a resultant force direction of a squeezing force applied to the movable assembly by the second elastic device.

Optionally, the camera module further includes a base. The base is provided with a support component uniformly arranged around the base, and the support component includes a first component and a second component. The first elastic device is installed in the first support component, and the second elastic device is installed in the second support component.

Optionally, the first support component has a first locking position and a second locking position, and the first elastic device includes a first metal sheet clamped at the first locking position and a first rolling member clamped at the second locking position. One side of the first rolling member is in contact with the first metal sheet, and the other side of the first rolling member passes through the second locking position and comes into contact with a guide rail of the movable assembly. When the movable assembly moves, a coil component of the movable assembly is electrically connected with the first rolling member, the first metal sheet and a focusing control chip through the guide rail.

Optionally, the first metal sheet further has an elastic structure arranged on the first metal sheet and clamped at the first locking position.

Optionally the second support component has a third locking position and a fourth locking position, and the second elastic device includes a second metal sheet clamped at the third locking position and a second rolling member clamped at the fourth locking position. One side of the second rolling member is in contact with the second metal sheet, and the other side of the second rolling member passes through the fourth locking position and comes into contact with the guide rail of the movable assembly. When the movable assembly moves, the coil component of the movable assembly is electrically connected with the second rolling member, the second metal sheet and the focusing control chip through the guide rail.

Optionally, the second rolling member includes a metal post or a plurality of metal balls arranged side by side.

Optionally, the movable assembly includes a carrier, and the carrier has a through hole corresponding to the support component. After the carrier is installed on the base, the support component penetrates into the through hole.

Optionally, the carrier has a lens accommodating cavity which passes through and protrudes from a surface of the carrier, and the lens assembly is sleeved in the lens accommodating cavity.

Optionally, the camera module further includes a lens protective sleeve. The lens protective sleeve has a cavity, and the lens protective sleeve is sleeved on a top of the lens accommodating cavity. When the lens assembly moves, the lens assembly moves into the cavity to isolate from the outside.

Optionally, the camera module further includes an iron housing arranged around the base for accommodating the movable assembly. The movable assembly moves up and down along the direction of the optical axis in the iron housing.

Optionally, the camera module further includes a lens ring fixedly arranged at a top of the iron housing.

Optionally, the camera module further includes a flexible connection structure arranged between the lens ring and the iron housing and connected with a bottom of the lens protective sleeve, and a space is formed between the flexible connection structure and the lens protective sleeve and between the flexible connection structure and the lens ring to prevent foreign objects from entering to affect an optical performance of the camera module.

Optionally, the lens ring includes a bearing component arranged on the flexible connection structure, an elastic component arranged in the bearing component and a third rolling member arranged between the elastic component and the bearing component.

Optionally, the elastic component includes an elastic opening ring, and the bearing component includes an inner ring wall, an outer ring wall and an annular convex strip arranged between the inner ring wall and the outer ring wall. The annular convex strip is provided with a dispensing groove and an opening, and the dispensing groove is configured to accommodate glue to adhere to a ring body of the elastic opening ring. One side of the third rolling member is in contact with the elastic opening ring, and the elastic opening ring is in an elastic active state. The third rolling member is arranged in the opening, and the elastic opening ring is arranged between the outer ring wall and the annular convex strip.

Optionally, a number of openings is greater than or equal to three.

Optionally, the camera module further includes at least one locking structure arranged on the base. The locking structure includes a coil assembly and a magnet assembly facing the coil assembly. When the coil assembly is powered on, a magnetic field generated by the coil assembly interacts with a magnetic field of the magnet assembly to cause a relative movement between the coil assembly and the magnet assembly to lock or unlock the movable assembly.

Optionally, the locking structure further includes a fixing portion, and the fixing portion includes a fixing base and a slide rail arranged on the fixing base. The slide rail extends along a direction parallel to a movement direction of the magnet assembly or the coil assembly.

Optionally, the locking structure further includes an elastic support portion having one end fixedly connected with the magnet assembly.

Optionally, when the coil assembly is powered on to cause the relative movement between the coil assembly and the magnet assembly, the elastic support portion is compressed and the movable assembly is unlocked.

Optionally, when the coil assembly is powered off, the magnetic field of the coil assembly disappears, and the magnet assembly is driven by a rebound force of the elastic support portion to reset and the movable assembly is locked.

Optionally, the locking structure further includes a locking slider, and a sliding member is arranged between the locking slider and the slide rail.

Optionally, the locking slider has an accommodating chamber, and the magnet assembly is removably installed in the accommodating chamber.

Optionally, the locking slider has a locking tongue arranged on an outer wall of the accommodating chamber.

Optionally, the locking structure is arranged on the base between adjacent first support components or on the base between adjacent second support components, or simultaneously arranged on the base between adjacent first support components and on the base between adjacent second support components.

Optionally, the camera module further includes a plurality of magnets in a straight bar shape and symmetrically arranged on at least two opposite sides of the base, and the locking structure is arranged on another one side or two sides of the base.

Optionally, a groove is arranged on the side wall of the carrier, and when the movable assembly is unlocked, the locking tongue is located in the groove.

Optionally, the base is further provided with a wire buried layer embedded in the base, one end of the wire buried layer is connected with the first metal sheet and the second metal sheet, and the other end of the wire buried layer is connected with the focusing control chip through a printed circuit board.

Accordingly, the present disclosure provides a digital device. The digital device includes a device body and a camera module according to any one of preceding embodiments. The camera module is arranged in the device body.

The embodiments of the present disclosure have following advantages:

In the camera module according to some embodiments of the present disclosure, the elastic device is uniformly arranged around the movable assembly and comes into contact with the movable assembly to generate an elastic deformation to apply a squeezing force to the movable assembly. The resultant force direction of the squeezing force points towards the optical axis and is perpendicular to the optical axis. The elastic device includes a first elastic device and a second elastic device. The resultant force direction of the squeezing force applied to the movable assembly by the first elastic device is opposite to the resultant force direction of the squeezing force applied to the movable assembly by the second elastic device. In this way, when the movable assembly drives the lens assembly to move along the direction of the optical axis, the movement of the movable assembly in the direction perpendicular to the direction of the optical axis can be well restricted. Therefore, the movement of the movable assembly in the direction perpendicular to the direction of the optical axis is stable, which can ensure a stability of the movement of the camera module in a large stroke in the direction perpendicular to the direction of the optical axis.

Furthermore, the camera module further includes a lens ring, and the lens ring includes a bearing component arranged on the flexible connection structure, an elastic component arranged in the bearing component and a third rolling member arranged between the elastic component and the bearing component. The lens ring is distributed in the movement direction of the movable assembly, and the elastic device is uniformly distributed around the movable assembly in the direction perpendicular to the movable assembly. The elastic device comes into contact with the movable assembly and generates an elastic deformation. The lens ring is arranged corresponding to the elastic device to ensure a stability of the optical axis of the camera module in a large stroke, which can ensure an imaging quality of the camera module.

Furthermore, the camera module further includes at least one locking structure arranged on the base, and the locking structure includes a coil assembly and a magnet assembly facing the coil assembly. When the coil assembly is powered on, a direction of a magnetic field generated by the coil assembly is opposite to a direction of a magnetic field of the magnet assembly to cause a relative movement between the coil assembly and the magnet assembly to lock or unlock the movable assembly. The locking structure can be configured as an independent structure in conjunction with the movable assembly and the elastic device, so that when using the camera module, the locking structure can be tested separately, which helps to improve product yield.

Furthermore, by reasonably setting the distribution relationship between the locking structure, the magnet and electrical connection parts on the base, the camera module can have a compact structure, which can reduce the volume and thickness of the camera module and adapt to a development trend of lightweight digital products.

Furthermore, when the coil assembly is powered off, the magnetic field of the coil assembly disappears, thus the magnetic assembly is driven to reset by the rebound force of the elastic support portion and the movable assembly is locked, so that when the camera module is not working, the presence of the locking structure can limit the movement of the camera module in the direction perpendicular to the direction of the optical axis, which can protect the camera module.

### BRIEF DESCRIPTION OF THE DRAWINGS

FIG. 1 illustrates a schematic structure view of a camera module according to an embodiment of the present disclosure;

FIG. 2 illustrates an exploded structure view of a camera module according to an embodiment of the present disclosure;

FIG. 3 illustrates a schematic structure view of a base according to an embodiment of the present disclosure;

FIG. 4 illustrates a schematic structure view of the base and a carrier according to an embodiment of the present disclosure;

FIG. 5 illustrates an exploded structure view of a locking structure according to an embodiment of the present disclosure;

FIG. 6 illustrates a top side view of FIG. 1 after assembly;

FIG. 7 illustrates a cross-sectional view of the camera module along a direction parallel to a direction of an optical axis according to an embodiment of the present disclosure; and

FIG. 8 illustrates an enlarged view of a first elastic device and a second elastic device according to an embodiment of the present disclosure.

### DETAILED DESCRIPTION

As mentioned in the background, how to effectively limit a movement of a camera module in a direction perpendicular to an optical axis and improve a stability of the camera module is one urgent problem to be solved in the field of camera modules.

An embodiment of the present disclosure provides a camera module, which can ensure the stability of the camera module during the operation of the camera module. When a movable assembly drives a lens assembly to move along a direction of an optical axis, the movement of the movable assembly in a direction perpendicular to the direction of the optical axis can be well restricted. Therefore, the movement of the movable assembly in the direction perpendicular to the direction of the optical axis is stable, which can ensure the stability of the movement of the camera module in a large stroke in the direction perpendicular to the direction of the optical axis.

In order to make above objectives, features and advantages of the present disclosure more obvious and understandable, specific embodiments of the present disclosure will be explained in detail below in conjunction with accompanying drawings.

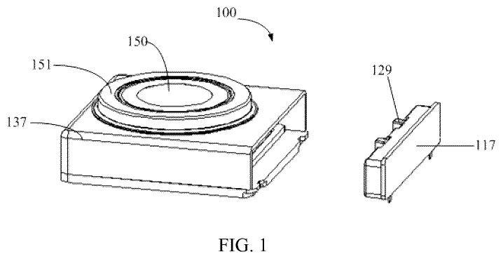

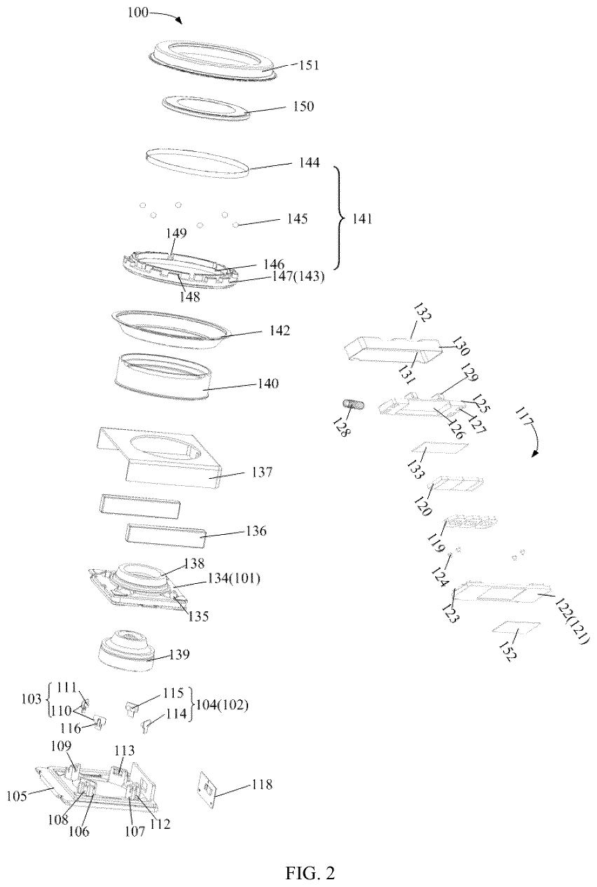

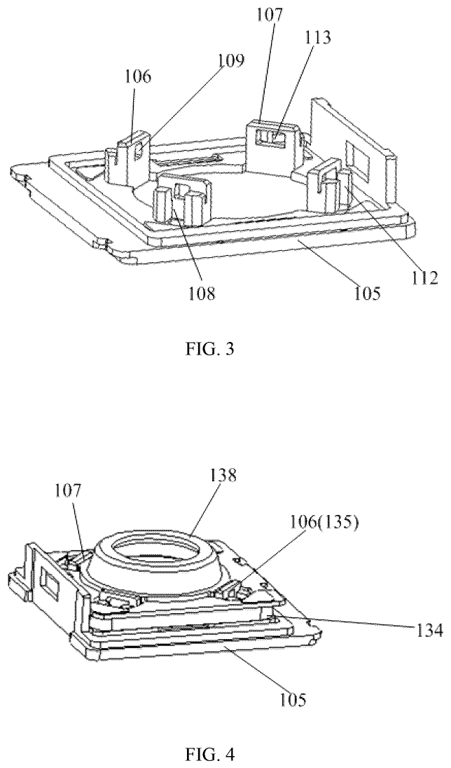

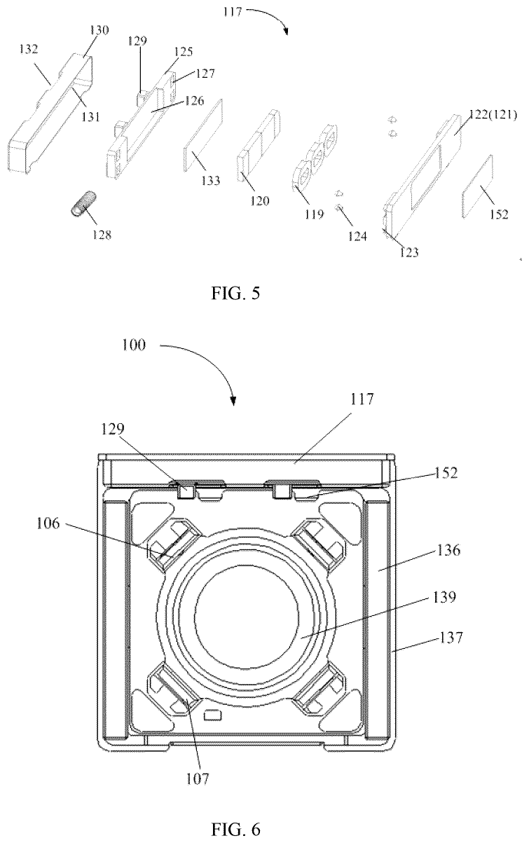

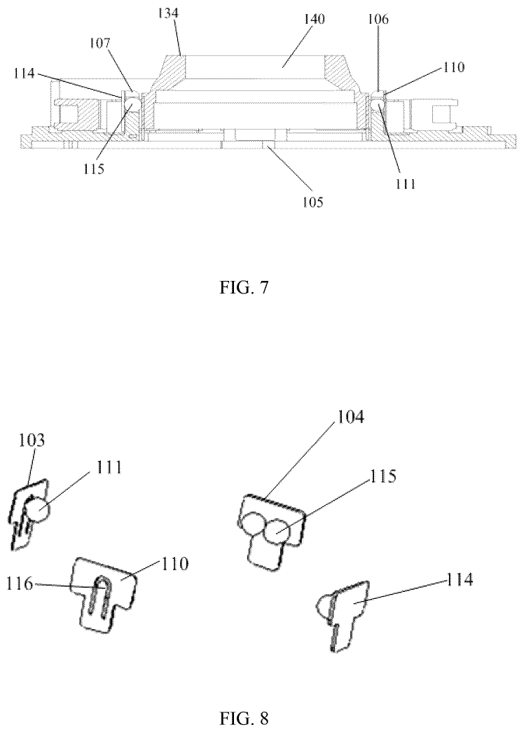

FIG. 1 illustrates a schematic structure view of a camera module according to an embodiment of the present disclosure. FIG. 2 illustrates an exploded structure view of a camera module according to an embodiment of the present disclosure. FIG. 3 illustrates a schematic structure view of a base according to an embodiment of the present disclosure. FIG. 4 illustrates a schematic structure view of the base and a carrier according to an embodiment of the present disclosure. FIG. 5 illustrates an exploded structure view of a locking structure according to an embodiment of the present disclosure. FIG. 6 illustrates a top side view of FIG. 1 after assembly. FIG. 7 illustrates a cross-sectional view of the camera module along a direction parallel to a direction of an optical axis according to an embodiment of the present disclosure. FIG. 8 illustrates an enlarged view of a first elastic device and a second elastic device according to an embodiment of the present disclosure.

In order to clearly show a relationship between an elastic device and a movable assembly, some components on the camera module are omitted in FIG. 7.

Referring to FIGS. 1 to 4, a camera module 100 includes a movable assembly 101 and an elastic device 102.

The movable assembly 101 is configured to drive a lens assembly to move along a direction of an optical axis.

The elastic device 102 is uniformly arranged around the movable assembly 101 and configured to come into contact with the movable assembly 101 to generate an elastic deformation to apply a squeezing force to the movable assembly 101. A resultant force direction of the squeezing force points towards the optical axis and is perpendicular to the optical axis. The elastic device 102 includes a first elastic device 103 and a second elastic device 104, and a resultant force direction of a squeezing force applied to the movable assembly 101 by the first elastic device 103 is opposite to a resultant force direction of a squeezing force applied to the movable assembly 101 by the second elastic device 104.

In some embodiments, due to uniform arrangement of the elastic device 102 around the movable assembly 101, when the elastic device 102 comes into contact with the movable assembly 101 to generate an elastic deformation, the elastic device 102 applies a squeezing force to the movable assembly 101. The resultant force direction of the squeezing force points towards the optical axis and is perpendicular to the optical axis. Since the squeezing force comes from the first elastic device 103 and the second elastic device 104, and the resultant force direction of the squeezing force of the first elastic device 103 on the movable assembly 101 is opposite to the resultant force direction of the squeezing force of the second elastic device 104 on the movable assembly 101, so that when the movable assembly 101 moves along the direction of the optical axis, the squeezing force in the direction perpendicular to the direction of the optical axis restricts the movement of the movable assembly 101 in the direction perpendicular to direction of the optical axis, which can improve the stability of the movement of the camera module in a large stroke in the direction perpendicular to the direction of the optical axis and improve an imaging quality of the camera module 100.

Still referring to FIG. 1, the camera module 100 further includes a base 105.

In some embodiments, the base 105 includes a support component uniformly arranged around the base 105. The support component 105 includes a first support component 106 and a second support component 107. The first elastic device 103 is installed in the first support component 106, and the second elastic device 104 is installed in the second support component 107.

In some embodiments, the base 105 is used to support the movable assembly 101, and the movable assembly 101 moves along the direction of the optical axis relative to the base 105.

In some embodiments, the first support component 106 has a first locking position 108 and a second locking position 109, and the first elastic device 103 includes a first metal sheet 110 clamped at the first locking position 108 and a first rolling member 111 clamped at the second locking position 109. One side of the first rolling member 111 is fixed on the first metal sheet 110, and the other side of the first rolling member 111 passes through the second locking position 109 and comes into contact with a coil component of the movable assembly 101. When the movable assembly 101 moves, the coil component of the movable assembly 101 is electrically connected with a focusing control chip through the first rolling element 111 and the first metal sheet 110.

In some embodiments, the second support component 107 has a third locking position 112 and a fourth locking position 113, and the second elastic device 104 includes a second metal sheet 114 clamped at the third locking position 112 and a second rolling member 115 clamped at the fourth locking position 113. One side of the second rolling member 115 is fixed on the second metal sheet 114, and the other side of the second rolling member 115 passes through the fourth locking position 113 and comes into contact with the coil component of the movable assembly 101. When the movable assembly 101 moves, the coil component of the movable assembly 101 is electrically connected with the focusing control chip through the second rolling member 115 and the second metal sheet 114.

In some embodiments, the coil component is provided with a guide rail. The guide rail electrical contacts the first rolling member 111 and the second rolling member 115 respectively, and provides a rolling stroke for the first rolling member 111 and the second rolling member 115 at on one side of the coil component.

In some embodiments, the first metal sheet 110 and the second metal sheet 114 may be a straight sheet, which facilitates the vertical insertion of the first metal sheet into the first locking position 108 and the vertical insertion of the second metal sheet into the third locking position 112, thereby facilitating assembly, simplifying installation process and improving efficiency.

In some embodiments, as the first elastic device 103 is arranged on the first support component 106 and the second elastic device 104 is arranged on the second support component 107, and the first support component 106 and the second support component 107 are uniformly arranged around the movable assembly 101, the movable assembly 101 is uniformly subjected to a squeezing force in all directions perpendicular to the direction of the optical axis, which can enhance a torsional resistance of the movable assembly 101 and enhance a stability of the movement in the direction perpendicular to the direction of the optical axis.

In some embodiments, the first metal sheet 110 is provided with an elastic structure 116, and the elastic structure 116 and the first rolling member 111 are arranged on two opposite surfaces of the first metal sheet 110, respectively.

In some embodiments, the first metal sheet 110 is provided with an elastic structure 116, which can provide a lateral force to ensure that the movable assembly 101 can move along the first support component 106.

In some embodiments, referring to FIG. 8, the second rolling member 115 may include a plurality of metal balls arranged side by side. For example, the second rolling member 115 may include two metal balls.

In other embodiments, the second rolling member 115 may also include a metal post or three or four metal balls arranged side by side, which can be set according to actual needs.

In some embodiments, the second rolling member including two metal balls arranged side by side can increase a contact area between the second rolling member 115 and the coil component. On the one hand, a conductivity between the second rolling member 115 and the coil component can be increased, and on the other hand, due to the increased contact area between the second rolling member 115 and the coil component, the difficulty of twisting the lens assembly in the direction perpendicular to the direction of the optical axis is increased, which can reduce a twisting angle of the lens assembly in the direction perpendicular to the direction of the optical axis, and improve the stability of the lens assembly in the direction perpendicular to direction of the optical axis.

In some embodiments, the base 105 also has a wire burial layer (not shown in the figure). The wire burial layer is embedded in the base 105. One end of the wire burial layer is connected with the first metal sheet 110 and the second metal sheet 114, and the other end of the wire burial layer is connected with the focusing control chip through a PCB circuit.

Referring to FIGS. 1, 5 and 6, at least one locking structure 117 is provided.

In some embodiments, when the camera module 100 is not operating, the locking structure 117 can lock the movable assembly 101 in the direction perpendicular to the direction of the optical axis, which can enhance the protective effect on the mobile assembly 101.

In some embodiments, the locking structure 117 is installed on the base 105, and the locking structure 117 and a circuit device 118 on the base 105 are arranged on two opposite sides of the base 105.

The circuit device 118 includes a Hall device, etc.

The locking structure 113 includes a coil assembly 119 and a magnet assembly 120. The magnet assembly 120 is arranged opposite to the coil assembly 119. When the coil assembly 119 is powered on, a direction of a magnetic field generated by the coil assembly 119 is opposite to a direction of a magnetic field of the magnet assembly 120 to cause a relative movement between the coil assembly 119 and the magnet assembly 120 to lock or unlock the movable assembly 101.

In some embodiments, the direction of the magnetic field generated by the coil assembly 119 is opposite to the direction of the magnetic field of the magnet assembly 120 when powered on, which causes the relative movement between the coil assembly 119 and the magnet assembly 120. The locking structure 117 has a simple and stable structure and ensures a better reliability of the electrical connection.

In some embodiments, one locking structure 117 may be provided.

In other embodiments, more than one locking structure 117 may be provided. The number of the locking structures may be selected based on actual design of the camera module 100.

In some embodiments, the locking structure 117 is arranged on the base 105 between adjacent first support components 106.

In other embodiments, the locking structure 117 may also be arranged on the base 105 between adjacent second support components 107, or simultaneously arranged on the base 106 between adjacent first support components 106 and between adjacent second support components 107.

In some embodiments, still referring to FIG. 5, the locking structure 117 further includes a fixing portion 121. The fixing portion 121 includes a fixing base 122 and a slide rail 123 arranged on the fixing base 122. The slide rail 123 extends in a direction parallel to a movement direction of the magnet assembly 120 or the coil assembly 119.

In some embodiments, a sliding member 124 is arranged in the guide rail 123. One side of the sliding member 124 is in contact with the slide rail 123 for sliding in the slide rail 123, and the other side of the sliding member 124 is relatively fixed with the magnet assembly 120 or the coil assembly 119 to drive the magnet assembly 120 or the coil assembly 119 to move.

Still referring to FIG. 5, the locking structure 117 further includes a locking slider 125.

In some embodiments, the locking slider 125 has an accommodating chamber 126, and the magnet assembly 120 is removably installed in the accommodating chamber 126. The other side of the sliding member 124 is clamped in the clamping groove 127 on the locking slider 125, thus when the sliding member 124 slides in the slide rail 123, the sliding member 124 drives the magnet assembly 120 to slide relative to the coil assembly 119.

In other embodiments, the magnet assembly 120 may also be fixed and the coil assembly 119 may slide relative to the magnet assembly 120.

Still referring to FIG. 5, the locking structure 117 further includes an elastic support portion 128.

One end of the elastic support portion 128 is fixed to the magnet assembly 120.

In some embodiments, one end of the elastic support portion 128 is connected with a side wall of the accommodating chamber 126, thereby forming a relative fixation between the elastic support portion 128 and the magnetic assembly 120.

In some embodiments, the elastic support portion 128 may be bonded to the side wall of the accommodating chamber 126.

In other embodiments, the elastic support portion 128 may also be clamped to the side wall of the accommodating chamber 126.

In some embodiments, when the coil assembly 119 is powered on, there is a relative movement between the coil assembly 119 and the magnet assembly 120, and the other end of the elastic support portion 128 is compressed, so that the elastic support portion 128 is in a compressed state and the movable assembly 101 is unlocked.

In some embodiments, when the coil assembly 119 is powered off, the magnetic field of the coil assembly 119 disappears, the magnet assembly 120 is driven by a rebound force of the elastic support portion 128 to reset and the movable assembly 101 is locked.

Still referring to FIGS. 5 and 6, the locking slider 125 has a locking tongue 129.

In some embodiments, the locking tongue 129 is arranged on an outer wall of the accommodating chamber 126.

When the coil assembly 119 is powered off, the locking tongue 129 slides onto the movable assembly 101 to lock the movable assembly 101. When the coil assembly 119 is powered on, the locking tongue 129 slides into a groove 152 on the movable assembly 101 to unlock the movable assembly 101.

Specifically, in some embodiments, the groove 152 is arranged on a side wall of a carrier. When the movable assembly 101 is unlocked, the locking tongue 129 is located in the groove 152.

In some embodiments, the locking structure 117 further includes a housing 130. One side of the housing 130 is provided with an installation groove 131, and the locking slider 125 is installed in the installation groove 131. When the coil assembly 119 moves relative to the magnetic assembly 120, the other end of the elastic support portion 128 abuts against a side wall of the installation groove 131 to be compressed. The installation groove 131 has a perforation hole 132, and the locking tongue 129 passes through the perforation hole 132.

In some embodiments, the locking structure 117 further includes a reinforcement magnetic conductive sheet 133 adsorbed to a surface of the magnetic assembly 120, and the reinforcement magnetic conductive sheet 133 is arranged between the magnetic assembly 120 and the accommodating chamber 126.

In some embodiments, the reinforcement magnetic conductive sheet 133 can increase the magnetism of the magnetic assembly 120.

In some embodiments, an adsorption magnetic conductive sheet 152 is further provided. The adsorption magnetic conductive sheet 152 is arranged on the fixing base 122. The adsorption magnetic conductive sheet 152 and the slide rail 123 are arranged on two opposite sides of the fixing base 122 for adsorbing the magnetic assembly 120 on the fixing base 122.

Still referring to FIGS. 2 and 4, the mobile assembly 101 includes a carrier 134.

In some embodiments, the carrier 134 has a through hole 135 corresponding to the support component. After the carrier 134 is installed on the base 105, the support component penetrates into the through hole 135, thereby forming a relative fixation between the movable assembly 101 and the base 105.

Still referring to FIGS. 2 and 6, the camera module further includes a plurality of magnets 136.

In some embodiments, the magnets 136 are in a straight bar shape and symmetrically arranged on at least two opposite sides of the base 105, and the locking structure 117 is arranged on another one side or two sides of the base 105.

In some embodiments, the magnets 136 are in a straight bar shape, which is easy to process and assemble.

Still referring to FIG. 2, the camera module further includes an iron housing 137.

In some embodiments, the iron housing 137 is arranged around the base 105 for accommodating the movable assembly 101, the magnets 136 and the locking structure 117. The movable assembly 101 moves up and down along the direction of the optical axis in the iron housing 137.

Still referring to FIG. 1, the carrier 134 has a lens accommodating cavity 138. The lens accommodating cavity 138 passes through and protrudes from a surface of the carrier 134, and the lens assembly 139 of the movable assembly 101 is sleeved in the lens accommodating cavity 138.

Still referring to FIG. 2, the camera module further includes a lens protective sleeve 140.

The lens protective sleeve 140 has a cavity, and the lens protective sleeve 140 is sleeved on a top of the lens accommodating cavity 138. When the lens assembly 139 moves, the lens assembly 139 moves into the cavity to isolate from the outside.

Still referring to FIG. 2, the camera module further includes a lens ring 141.

The lens ring 141 is fixed to a top of the iron housing 137.

In some embodiments, the lens ring 141 is distributed in the movement direction of the movable assembly 101, and the elastic device 102 is uniformly distributed around the movable assembly 101 in a direction perpendicular to the movable assembly 101. The elastic device 102 contacts the movable assembly to generate an elastic deformation. The lens ring 141 is arranged corresponding to the elastic device 102 to ensure a stability of the optical axis of the camera module in a large stroke to ensure the imaging quality of the camera module.

In some embodiments, the camera module further includes a flexible connection structure 142. The flexible connection structure 142 is arranged between the lens ring 141 and the iron housing 137 and connected to a bottom of the lens protective sleeve 140. A space is formed between the flexible connection structure 142 and the lens protective sleeve 140 and between the flexible connection structure 142 and the lens ring 141 to prevent foreign objects from entering to affect an optical performance of the camera module.

The foreign objects include impurities such as water, oil, dust, etc., which may affect the clarity of the lens assembly.

In some embodiments, the lens ring 141 includes a bearing component 143 arranged on the flexible connection structure 142, an elastic component 144 arranged in the bearing component 143, and a third rolling member 145 arranged between the elastic component 144 and the bearing component 143.

In some embodiments, when the lens assembly 139 is subjected to a force on one side, a rebound force of the elastic component 144 can force the lens assembly 139 to reset to an original position to maintain the movement direction of the lens assembly 139 to be consistent with the direction of the optical axis.

In some embodiments, the elastic component 144 includes an elastic opening ring, and the bearing component 143 includes an inner ring wall 146, an outer ring wall 147 and an annular convex strip 148 arranged between the inner ring wall 146 and the outer ring wall 147. The annular convex strip 148 is provided with a dispensing groove (not marked in the figure) and an opening 149. The dispensing groove is configured to accommodate glue to adhere to a ring body of the elastic opening ring. One side of the third rolling member 145 is in contact with the elastic opening ring, and the elastic opening ring is in an elastic active state. The third rolling member 145 is arranged in the opening 149, and the elastic opening ring is arranged between the outer ring wall 147 and the annular convex strip 148.

In some embodiments, the number of openings 149 is greater than or equal to three.

In some embodiments, the third rolling member 145 is a steel ball, and a friction between the steel ball and a moving member is a rolling friction with a small friction coefficient, which can make the moving member move more smoothly.

The soft connection structure is connected with the lens protective sleeve

In some embodiments, the camera module further includes a protective glass 150 and a protective housing 151 for sealing the lens assembly 139 and completely isolating the lens assembly 139 from the external environment by wrapping the entire lens assembly 130 inside.

Accordingly, the present disclosure provides a digital device. The digital device includes a device body and a camera module 100 according to any one of preceding embodiments. The camera module 100 is arranged in the device body.

Although the present disclosure has been disclosed above, the present disclosure is not limited thereto. Any changes and modifications may be made by those skilled in the art without departing from the spirit and scope of the present disclosure, and the scope of the present disclosure should be determined by the appended claims.

1. A camera module, comprising:
a movable assembly configured to drive a lens assembly to move along a direction of an optical axis; and
an elastic device uniformly arranged around the movable assembly and configured to come into contact with the movable assembly to generate an elastic deformation to apply a squeezing force to the movable assembly, wherein a resultant force direction of the squeezing force points towards the optical axis and is perpendicular to the optical axis;
wherein the elastic device comprises a first elastic device and a second elastic device, and a resultant force direction of a squeezing force applied to the movable assembly by the first elastic device is opposite to a resultant force direction of a squeezing force applied to the movable assembly by the second elastic device.

2. The camera module according to claim 1, further comprising a base, wherein the base is provided with a support component uniformly arranged around the base, and the support component comprises a first component and a second component, wherein the first elastic device is installed in the first support component, and the second elastic device is installed in the second support component.

3. The camera module according to claim 2, wherein the first support component has a first locking position and a second locking position, and the first elastic device comprises a first metal sheet clamped at the first locking position and a first rolling member clamped at the second locking position, wherein one side of the first rolling member is in contact with the first metal sheet, and the other side of the first rolling member passes through the second locking position and comes into contact with a guide rail of the movable assembly, wherein when the movable assembly moves, a coil component of the movable assembly is electrically connected with the first rolling member, the first metal sheet and a focusing control chip through the guide rail.

4. The camera module according to claim 3, wherein the first metal sheet further has an elastic structure arranged on the first metal sheet and clamped at the first locking position.

5. The camera module according to claim 3, wherein the second support component has a third locking position and a fourth locking position, and the second elastic device comprises a second metal sheet clamped at the third locking position and a second rolling member clamped at the fourth locking position, wherein one side of the second rolling member is in contact with the second metal sheet, and the other side of the second rolling member passes through the fourth locking position and comes into contact with the guide rail of the movable assembly, wherein when the movable assembly moves, the coil component of the movable assembly is electrically connected with the second rolling member, the second metal sheet and the focusing control chip through the guide rail.

6. The camera module according to claim 5, wherein the second rolling member comprises a metal post or a plurality of metal balls arranged side by side; or
the base is further provided with a wire buried layer embedded in the base, one end of the wire buried layer is connected with the first metal sheet and the second metal sheet, and the other end of the wire buried layer is connected with the focusing control chip through a printed circuit board.

7. The camera module according to claim 2, wherein the movable assembly comprises a carrier, and the carrier has a through hole corresponding to the support component, wherein after the carrier is installed on the base, the support component penetrates into the through hole.

8. The camera module according to claim 7, wherein the carrier has a lens accommodating cavity which passes through and protrudes from a surface of the carrier, and the lens assembly is sleeved in the lens accommodating cavity.

9. The camera module according to claim 8, further comprising a lens protective sleeve, wherein the lens protective sleeve has a cavity, and the lens protective sleeve is sleeved on a top of the lens accommodating cavity, wherein when the lens assembly moves, the lens assembly moves into the cavity to isolate from the outside.

10. The camera module according to claim 9, further comprising an iron housing arranged around the base for accommodating the movable assembly and a lens ring fixedly arranged at a top of the iron housing, wherein the movable assembly moves up and down along the direction of the optical axis in the iron housing.

11. (canceled)

12. The camera module according to claim 10, further comprising a flexible connection structure arranged between the lens ring and the iron housing and connected with a bottom of the lens protective sleeve, wherein a space is formed between the flexible connection structure and the lens protective sleeve and between the flexible connection structure and the lens ring to prevent foreign objects from entering to affect an optical performance of the camera module.

13. The camera module according to claim 12, wherein the lens ring comprises a bearing component arranged on the flexible connection structure, an elastic component arranged in the bearing component and a third rolling member arranged between the elastic component and the bearing component.

14. The camera module according to claim 13, wherein the elastic component comprises an elastic opening ring, and the bearing component comprises an inner ring wall, an outer ring wall and an annular convex strip arranged between the inner ring wall and the outer ring wall, wherein the annular convex strip is provided with a dispensing groove and an opening, and the dispensing groove is configured to accommodate glue to adhere to a ring body of the elastic opening ring, wherein one side of the third rolling member is in contact with the elastic opening ring, and the elastic opening ring is in an elastic active state, wherein the third rolling member is arranged in the opening, and the elastic opening ring is arranged between the outer ring wall and the annular convex strip.

15. (canceled)

16. The camera module according to claim 7, further comprising at least one locking structure arranged on the base, wherein the locking structure comprises a coil assembly and a magnet assembly facing the coil assembly, wherein when the coil assembly is powered on, a magnetic field generated by the coil assembly interacts with a magnetic field of the magnet assembly to cause a relative movement between the coil assembly and the magnet assembly to lock or unlock the movable assembly.

17. The camera module according to claim 16, wherein the locking structure further comprises a fixing portion, and the fixing portion comprises a fixing base and a slide rail arranged on the fixing base, wherein the slide rail extends along a direction parallel to a movement direction of the magnet assembly or the coil assembly; or
the locking structure further comprises an elastic support portion having one end fixedly connected with the magnet assembly.

18. (canceled)

19. The camera module according to claim 17, wherein when the coil assembly is powered on to cause the relative movement between the coil assembly and the magnet assembly, the elastic support portion is compressed and the movable assembly is unlocked; wherein when the coil assembly is powered off, the magnetic field of the coil assembly disappears, and the magnet assembly is driven by a rebound force of the elastic support portion to reset and the movable assembly is locked.

20. (canceled)

21. The camera module according to claim 17, wherein the locking structure further comprises a locking slider, and a sliding member is arranged between the locking slider and the slide rail.

22. The camera module according to claim 21, wherein the locking slider has an accommodating chamber, and the magnet assembly is removably installed in the accommodating chamber, wherein the locking slider has a locking tongue arranged on an outer wall of the accommodating chamber, wherein a groove is arranged on the side wall of the carrier, and when the movable assembly is unlocked, the locking tongue is located in the groove.

23. (canceled)

24. The camera module according to claim 16, wherein the locking structure is arranged on the base between adjacent first support components or on the base between adjacent second support components, or simultaneously arranged on the base between adjacent first support components and on the base between adjacent second support components; or
the camera module further comprises a plurality of magnets in a straight bar shape and symmetrically arranged on at least two opposite sides of the base, and the locking structure is arranged on another one side or two sides of the base.

25-27. (canceled)

28. A digital device, comprising:
a device body; and
a camera module according to claim 1, wherein the camera module is arranged in the device body.
